(19) United States
(12) Patent Application Publication
(10) Pub. No.: US 2021/0013517 A1
(43) Pub. Date: Jan. 14, 2021

(54) BATTERY

(71) Applicant: Exa Energy Technology Co., Ltd., Taichung City (TW)

(72) Inventors: Lun-Chieh HO, Taichung City (TW); Yi-Ting GAU, Taichung City (TW); Han-Chen CHEN, Taichung City (TW)

(21) Appl. No.: 16/922,509

(22) Filed: Jul. 7, 2020

(30) Foreign Application Priority Data
Jul. 11, 2019 (TW) 108209062

(51) Int. Cl. H01M 4/70; H01M 2/26; H01M 4/66; H01M 10/0585; H01M 2/08

(52) U.S. Cl. CPC H01M 4/70; H01M 2/26; H01M 2/08; H01M 10/0585; H01M 4/667

(57) ABSTRACT

A battery is provided. A first conducting pole is disposed on a first outer layer and extends partially on a first sealing layer, and a first electrode is disposed on the first conducting pole and separate from the first sealing layer. A second conducting pole is disposed on a second outer layer and extends partially on the second sealing layer, and a second electrode is disposed on the second conducting pole and separate from the second sealing layer. An isolation membrane is attached to the first and second electrodes. One of two binding layers bound together is interposed between the first conducting pole and a part of the first outer layer protrusive beyond the second outer layer, the other of the two binding layers being interposed between the second conducting pole and a part of the first outer layer protrusive beyond the second outer layer.

### BACKGROUND OF THE INVENTION

### Field of the Invention

The present invention relates to a battery.

### Description of the Prior Art

In recent years, with the development of technology, the demand for thin batteries has increased significantly. Especially in the popular portable electronic devices, the thickness and performance of a thin battery has significantly improved.

In general, the structure of the thin battery, such as described in TW 481935, includes a sheet-shaped electrode plate and a conductive pole overlapping with each other and provided inside the outer package, wherein the conductive pole protrudes out of the outer package for connection to an electronic device.

However, the conductive pole protruding beyond the outer package is easy to be inadvertently broken, which can cause failure or low performance of electrical connection of the conductive pole and can cause poor product yield.

The present invention is, therefore, arisen to obviate or at least mitigate the above-mentioned disadvantages.

### SUMMARY OF THE INVENTION

The main object of the present invention is to provide a battery which has a strong structure with sufficient strength and toughness and is uneasy to be broken.

To achieve the above and other objects, a battery is provided, including: a first outer layer and a second outer layer, each of the first outer layer and the second outer layer being coated with a plastic layer on a side thereof, a length of the first outer layer in a longitudinal direction being larger than a length of the second outer layer in the longitudinal direction; a first sealing layer and a second sealing layer, the first sealing layer disposed on an end of a face of the first outer layer coated with the plastic layer in the longitudinal direction, the second sealing layer disposed on an end of a face of the second outer layer coated with the plastic layer in the longitudinal direction; a first electrode structure and a second electrode structure, the first electrode structure including a first electrode and a first conducting pole, the second electrode structure including a second electrode and a second conducting pole, the first conducting pole disposed on the face of the first outer layer coated with the plastic layer and extending partially on the first sealing layer, the first electrode disposed on a face of the first conducting pole opposite to the first outer layer and separate from the first sealing layer, the second conducting pole disposed on the face of the second outer layer coated with the plastic layer and extending partially on the second sealing layer, the second electrode disposed on a face of the second conducting pole opposite to the second outer layer and separate from the second sealing layer; an isolation membrane, a face of the isolation membrane being attached to a face of the first electrode opposite to the first conducting pole, another face of the isolation membrane being attached to a face of the second electrode opposite to the second conducting pole; two binding layers, one of the two binding layers being interposed between the first conducting pole and a part of the first outer layer which is protrusive beyond the second outer layer, the other of the two binding layers being interposed between the second conducting pole and a part of the first outer layer which is protrusive beyond the second outer layer; wherein respective majorities of peripheral portions of the first outer layer and the second outer layer are sealed with the plastic layers integrally binding together by hot pressing, and after an electrolyte is disposed in the battery, the first and second sealing layers and the two binding layers are sealingly bound together.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a partial cross-sectional view of a preferable embodiment of the present invention;

FIG. 2 is a partial cross-sectional view of another preferable embodiment of the present invention;

FIG. 3 is a drawing showing a first electrode structure according to a preferable embodiment of the present invention;

FIG. 4 is a stereogram of the first electrode structure according to a preferable embodiment of the present invention;

FIGS. 5 and 6 are drawings showing partial manufacturing processes according to a preferable embodiment of the present invention;

FIG. 7 is a breakdown drawing of a preferable embodiment of the present invention;

FIG. 8 is a side view of a preferable embodiment of the present invention; and

FIGS. 9 and 10 are drawings showing partial manufacturing processes according to a preferable embodiment of the present invention.

### DETAILED DESCRIPTION OF THE PREFERRED EMBODIMENTS

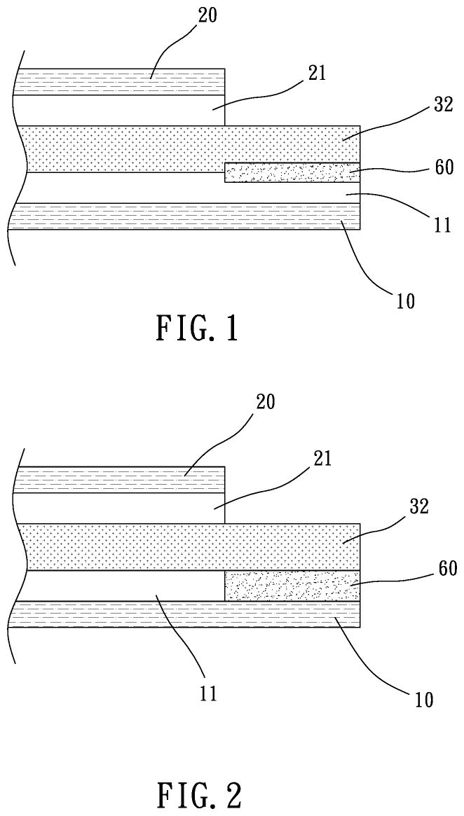

Please refer to FIGS. 1 to 9 for a preferable embodiment of the present invention. A battery 1 of the present invention includes a first outer layer 10, a second outer layer 20, a first sealing layer 11, a second sealing layer 21, a first electrode structure 30, a second electrode structure 40, an isolation membrane 50 and two binding layers 60.

Each of the first outer layer 10 and the second outer layer 20 is coated with a plastic layer on a side thereof, and a length of the first outer layer 10 in a longitudinal direction is larger than a length of the second outer layer 20 in the longitudinal direction. The first sealing layer 11 is disposed on an end of a face of the first outer layer 10 coated with the plastic layer in the longitudinal direction, and the second sealing layer 21 is disposed on an end of a face of the second outer layer 20 coated with the plastic layer in the longitudinal direction. The first electrode structure 30 includes a first electrode 31 and a first conducting pole 32, and the second electrode structure 40 includes a second electrode 41 and a second conducting pole 42. The first conducting pole 32 is disposed on the face of the first outer layer 10 coated with the plastic layer and extends partially on the first sealing layer 1, and the first electrode 31 is disposed on a face of the first conducting pole 32 opposite to the first outer layer 10 and separate from the first sealing layer 11. The second conducting pole 42 is disposed on the face of the second outer layer 20 coated with the plastic layer and extends partially on the second sealing layer 21, and the second electrode 41 is disposed on a face of the second conducting pole 42 opposite to the second outer layer 20 and separate from the second sealing layer 21. A face of the isolation membrane 50 is attached to a face of the first electrode 31 opposite to the first conducting pole 32, and another face of the isolation membrane is attached to a face of the second electrode 41 opposite to the second conducting pole 42 (preferably, two opposite faces of the isolation membrane 50 are treated by adhesive-spraying). One of the two binding layers 60 is interposed between the first conducting pole 32 and a part of the first outer layer 10 which is protrusive beyond the second outer layer 20, and the other of the two binding layers 60 is interposed between the second conducting pole 42 and a part of the first outer layer 10 which is protrusive beyond the second outer layer 20. Respective majorities of peripheral portions of the first outer layer 10 and the second outer layer 20 are sealed with the plastic layers integrally binding together by hot pressing, and after an electrolyte is disposed in the battery, the first and second outer layers 10, 20 and the two binding layers 60 are sealingly bound together.

In this embodiment, each of the first outer layer 10 and second outer layer 20 is an aluminum plastic film, and each of the two binding layers 60 is selected from the group consisting of acrylic polymer, epoxy polymer, methyl methacrylate polymer, polyether polyol mixture, cyanoacrylate polymer, neoprene rubber polymer and polyvinyl butyrate resin, wherein each of the two binding layers 60 is disposed to and within the battery by adhesive coating, adhesive film or double-sided tape. Each of the first sealing layer 11 and the second sealing layer 21 is preferably polypropylene layer.

The two binding layers 60 may be respectively interposed between the first sealing layer 11 and the first conducting pole 32 and between the first sealing layer and the second conducting pole (as shown in FIG. 1), or may be respectively interposed between the first outer layer 10 and the first conducting pole 32 and between the first outer layer and the second conducting pole (as shown in FIG. 2). Whereby, respective protrusive parts of first conducting pole 32 and second conducting pole stably attached on first outer layer 10, thus enhancing structure and toughness of the first conducting pole 32 and second conducting pole.

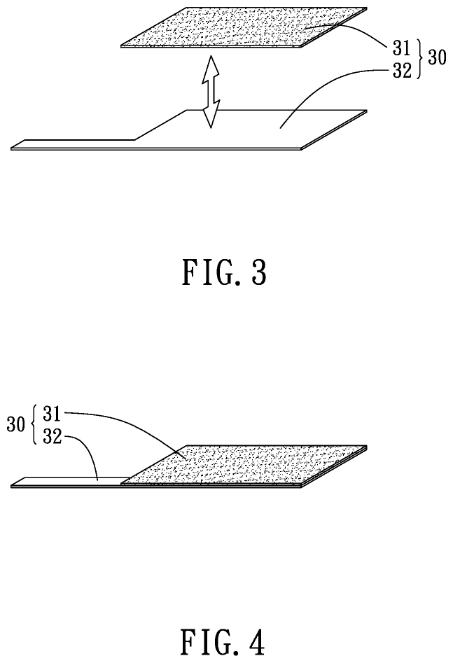

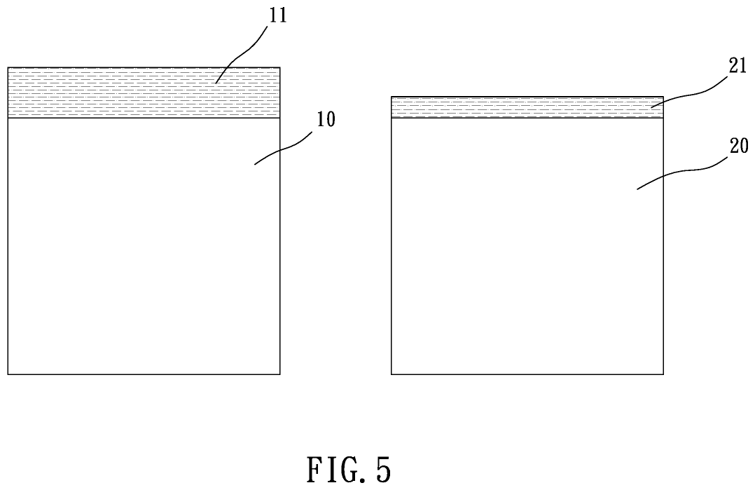

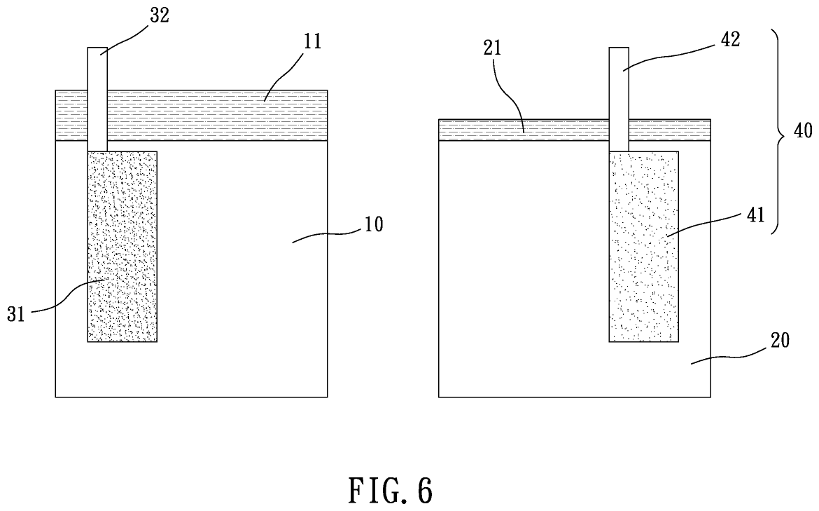

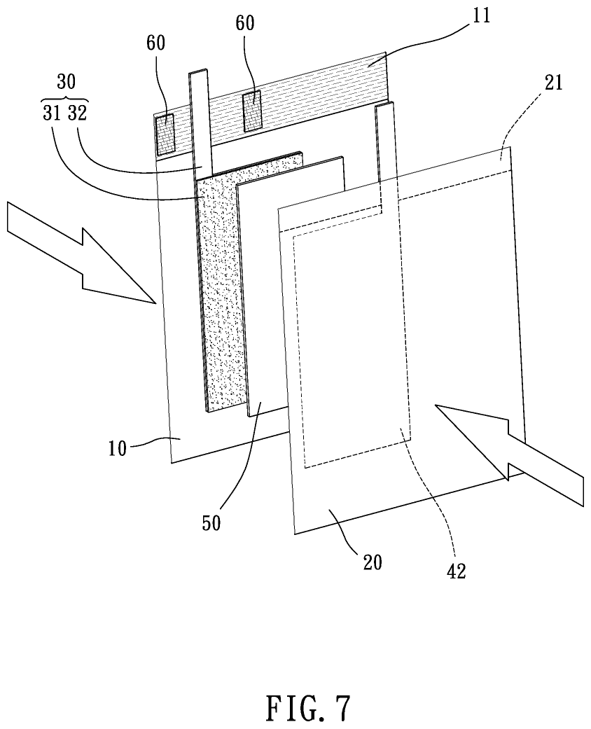

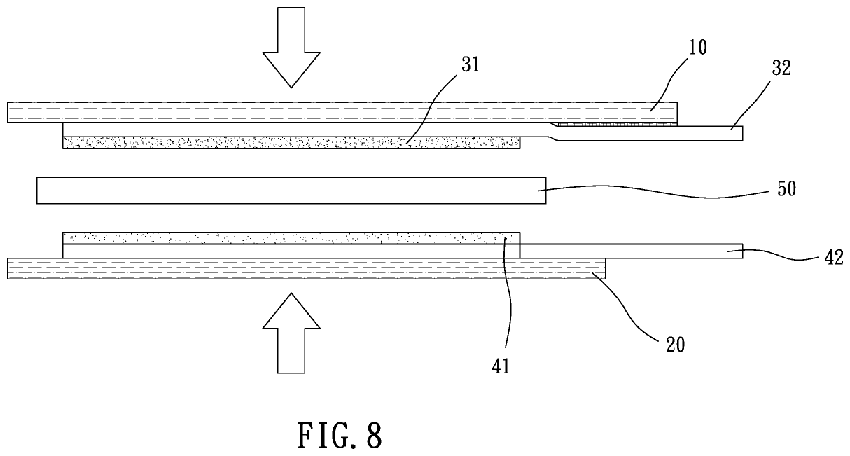

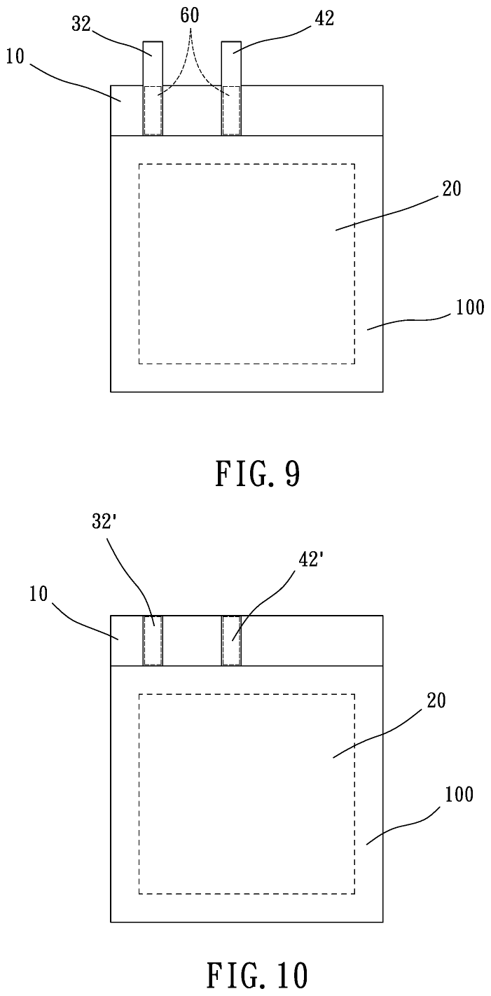

The manufacturing process includes steps of: preparing the first electrode structure 30 and the second electrode structure 40 (as shown in FIGS. 3 and 4); cutting conductive sheets to form the first electrode 31 and the second electrode, and stacking the first electrode 31 and the second electrode with the first conducting pole 32 and second conducting pole, respectively, as shown in FIG. 5, by hot pressing, binding the first sealing layer 11 and the second sealing layer 21 (such as polypropylene film) at the peripheral portions of first outer layer 10 and second outer layer 20; as shown in FIG. 6, disposing the first electrode structure 30 and the second electrode structure 40 on the first outer layer 10 and the second outer layer 20, respectively, so that the first conducting pole 32 and the second conducting pole 42 are respectively protrusive out of the first outer layer 10 and the second outer layer 20, respectively, and disposing the isolation membrane 50 between the first electrode 31 and the second electrode 41 (as shown in FIGS. 7 and 8); by hot pressing, binding respective majorities of peripheral portions of the first outer layer 10 and the second outer layer 20 to form a sealed portion 100, disposing the two binding layers 60 respectively between the first outer layer 20 and the first conducting pole 32 and between the first outer layer 20 and the second conducting pole 42, as shown in FIG. 9, disposing the electrolyte into and between the first sealing layer 11 and second sealing layer 21, and finally sealing the first sealing layer 11 and the second sealing layer 21.

After battery performance test, the first conducting pole 32 and the second conducting pole 42 are cut to form the first conducting pole 32′ and the second conducting pole 42′ which are not protrusive beyond the first outer layer 10 (as shown in FIG. 9), which prevents the first conducting pole and the second conducting pole form being damaged, crushed and/or broken.

In this embodiment, an aluminum foil is used to serve as a positive electrode and a cupper foil is used to serve as a negative electrode (first conducting pole and second conducting pole). As shown in the chart below, under the condition that the packaged battery is baked under 200° C. for 10 minutes, the peel force for each of the first conducting pole and the second conducting pole is greater than 0.5 kgw. With regard to a conducting pole of a conventional battery without binding layer applied thereto, the peel force for the conducting pole is too low to be measured (that is, the conducting pole can peel even under a very little peel force). It is obvious that the conducting pole can bear considerably higher peel force, thus having good structural strength and being uneasy to be broken.

| | | peel force (kgw) | | | | | | | |
|---|---|---|---|---|---|---|---|---|---|
| test | | conducting pole (aluminum) | | | | conducting pole (cupper) | | | |
| number | status | 1 | 2 | 3 | average | 1 | 2 | 3 | average |
| 1 | room | 0.298 | 0.227 | 0.267 | 0.264 | 0.242 | 0.331 | 0.259 | 0.277 |
| | temperature | | | | | | | | |
| 2 | 200° C. for | 0.474 | 0.448 | 0.425 | 0.449 | 0.438 | 0.439 | 0.360 | 0.412 |
| | 1 minute | | | | | | | | |
| 3 | 200° C. for | 0.614 | 0.607 | 0.542 | 0.588 | 0.791 | 0.768 | 0.528 | 0.696 |
| | 10 minutes | | | | | | | | |

With the above structure, the present invention can provide a battery having a strong conducting pole with sufficient strength and toughness. It can avoid the breakage or bending of the conducting pole without increasing the thickness and weight of the battery. Moreover, the manufacturing process is simple and the cost is reasonable, which is conducive to mass manufacturing and commercialization.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A battery, including:
a first outer layer and a second outer layer, each of the first outer layer and the second outer layer being coated with a plastic layer on a side thereof, a length of the first outer layer in a longitudinal direction being larger than a length of the second outer layer in the longitudinal direction;
a first sealing layer and a second sealing layer, the first sealing layer disposed on an end of a face of the first outer layer coated with the plastic layer in the longitudinal direction, the second sealing layer disposed on an end of a face of the second outer layer coated with the plastic layer in the longitudinal direction;
a first electrode structure and a second electrode structure, the first electrode structure including a first electrode and a first conducting pole, the second electrode structure including a second electrode and a second conducting pole, the first conducting pole disposed on the face of the first outer layer coated with the plastic layer and extending partially on the first sealing layer, the first electrode disposed on a face of the first conducting pole opposite to the first outer layer and separate from the first sealing layer, the second conducting pole disposed on the face of the second outer layer coated with the plastic layer and extending partially on the second sealing layer, the second electrode disposed on a face of the second conducting pole opposite to the second outer layer and separate from the second sealing layer;
an isolation membrane, a face of the isolation membrane being attached to a face of the first electrode opposite to the first conducting pole, another face of the isolation membrane being attached to a face of the second electrode opposite to the second conducting pole;
two binding layers, one of the two binding layers being interposed between the first conducting pole and a part of the first outer layer which is protrusive beyond the second outer layer, the other of the two binding layers being interposed between the second conducting pole and a part of the first outer layer which is protrusive beyond the second outer layer;
wherein respective majorities of peripheral portions of the first outer layer and the second outer layer are sealed with the plastic layers integrally binding together by hot pressing, and after an electrolyte is disposed in the battery, the first and second sealing layers and the two binding layers are sealingly bound together.

2. The battery of claim 1, wherein each of the first outer layer and second outer layer is an aluminum plastic film.

3. The battery of claim 1, wherein one of the two binding layers is interposed between the first sealing layer and the first conducting pole, and the other of the two binding layers is interposed between the first sealing layer and the second conducting pole.

4. The battery of claim 1, wherein one of the two binding layers is interposed between the first outer layer and the first conducting pole, and the other of the two binding layers is interposed between the first outer layer and the second conducting pole.

5. The battery of claim 1, wherein each of the two binding layers is selected from the group consisting of acrylic polymer, epoxy polymer, methyl methacrylate polymer, polyether polyol mixture, cyanoacrylate polymer, neoprene rubber polymer and polyvinyl butyrate resin.

6. The battery of claim 1, wherein each of the two binding layers is disposed to and within the battery by adhesive coating, adhesive film or double-sided tape.

7. The battery of claim 1, wherein each of the first sealing layer and the second sealing layer is a polypropylene layer.

8. The battery of claim 1, wherein two opposite faces of the isolation membrane are treated by adhesive-spraying.
